(19) United States
(12) Patent Application Publication
(10) Pub. No.: US 2016/0063728 A1
(43) Pub. Date: Mar. 3, 2016

(54) Intelligent Nanny Assistance

(71) Applicant: MediaTek Inc., Hsinchu (TW)

(72) Inventors: Tsung-Te Wang, Taipei (TW); Chun-Chia Chen, Hsinchu (TW)

(21) Appl. No.: 14/937,828

(22) Filed: Nov. 10, 2015

(51) Int. Cl. G06T 7/20; G08B 21/04; G06K 9/62; G06K 9/46; G06K 9/00

(52) U.S. Cl. CPC G06T 7/20; G06K 9/4671; G06K 9/00771; G06K 9/6262; G06K 9/6267; G08B 21/0476; G06K 2009/4666

(57) ABSTRACT

Methods and systems of an intelligent nanny assistant are described. A method may involve determining whether a subject of concern is approaching a predefined area of an environment. The method may also involve controlling one or more devices in the environment to provide information in a way that attracts the subject of concern to move away from the predefined area in response to a determination that the subject of concern is approaching the predefined area.

### TECHNICAL FIELD

The present disclosure is generally related to tracking and redirection of a subject of concern and, more particularly, to methods, apparatuses and systems pertaining to intelligent nanny assistance.

### BACKGROUND

In a household or a given environment where there is a crawling baby, a toddler, a young child or even a pet animal (hereinafter referred to as the “subject of concern” or, interchangeably, the “subject”), there exists the danger of the subject entering a dangerous or forbidden area and resulting in injury to the subject, damage to goods and/or loss in property. One approach to avoid aforementioned misfortunes from happening to a baby, toddler, young child or pet is to place the baby, toddler, young child or pet in a crib or pen. However, the growth, development and/or mood of a baby, toddler, young child or pet having been placed in a crib or pen for a long time tends to be negatively impacted. Another approach is to hire a full-time staff or nanny to take care of the baby, toddler, young child or pet. However, hiring a staff or nanny full-time tends to be cost prohibitive and, besides, there is still the risk of negligence and/or inadequate training or experience on the part of the staff or nanny. A further approach is to install a monitoring or surveillance system, such as a baby cam, to monitor the baby, toddler, young child or pet. However, such system is usually capable of passive actions such as providing real-time or recorded images and providing alerts and warnings, but not proactive actions such as preventing and/or stopping imminent injury or damage from happening.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to provide schemes, techniques, methods and systems for automatic recognition of a subject of concern in an environment and guiding the subject away from predefined area(s) of the environment in an event that the subject is determined to be approaching the predefined area(s). Advantageously, implementations of the present disclosure provide intelligent nanny assistance for safeguarding the subject of concern without aforementioned issues associated with conventional approaches.

In one aspect, a method may involve determining whether a subject of concern is approaching a predefined area of an environment. The method may also involve controlling one or more devices in the environment to provide information in a way that attracts the subject of concern to move away from the predefined area in response to a determination that the subject of concern is approaching the predefined area.

In another aspect, a method may involve periodically or continuously receiving image-related data from a monitoring system that monitors an environment. The method may also involve determining a subject in the environment as a subject of concern and determining a range of sight of the subject of concern. The method may further involve retrieving information related to one or more objects of interest of the subject of concern. The method may additionally involve controlling one or more devices in the environment to provide the information in a way that attracts the subject of concern to move away from a predefined area of the environment.

In yet another aspect, a system may include a monitoring system, an information output system, and a computing apparatus. The monitoring system may be configured to monitor an environment to periodically or continuously provide image-related data of the environment. The information output system may be situated in the environment and configured to provide visual information, audible information, or a combination thereof. The computing apparatus may be communicatively coupled to the monitoring system and the information output system. The computing apparatus may include a memory configured to store data and a processor configured to access the memory. The processor may be configured to receive image-related data from the monitoring system. The processor may be also configured to determine whether a subject of concern is approaching a predefined area of the environment based on the image-related data. The processor may be further configured to control the information output system to provide the visual information, the audible information, or both the visual information and the audible information in a way that attracts the subject of concern to move away from the predefined area in response to a determination that the subject of concern is approaching the predefined area.

### BRIEF DESCRIPTION OF THE DRAWINGS

The accompanying drawings are included to provide a further understanding of the disclosure, and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example environment in which various embodiments in accordance with the present disclosure may be implemented.

FIG. 2 is a flowchart of an example algorithm in accordance with an implementation of the present disclosure.

FIG. 3 is a flowchart of another example algorithm in accordance with an implementation of the present disclosure.

FIG. 4 is a flowchart of yet another example algorithm in accordance with an implementation of the present disclosure.

FIG. 5 is a simplified block diagram of an example system in accordance with an implementation of the present disclosure.

FIG. 6 is a flowchart of an example process in accordance with an implementation of the present disclosure.

FIG. 7 is a flowchart of another example algorithm in accordance with an implementation of the present disclosure.

### DETAILED DESCRIPTION OF PREFERRED IMPLEMENTATIONS

### Overview

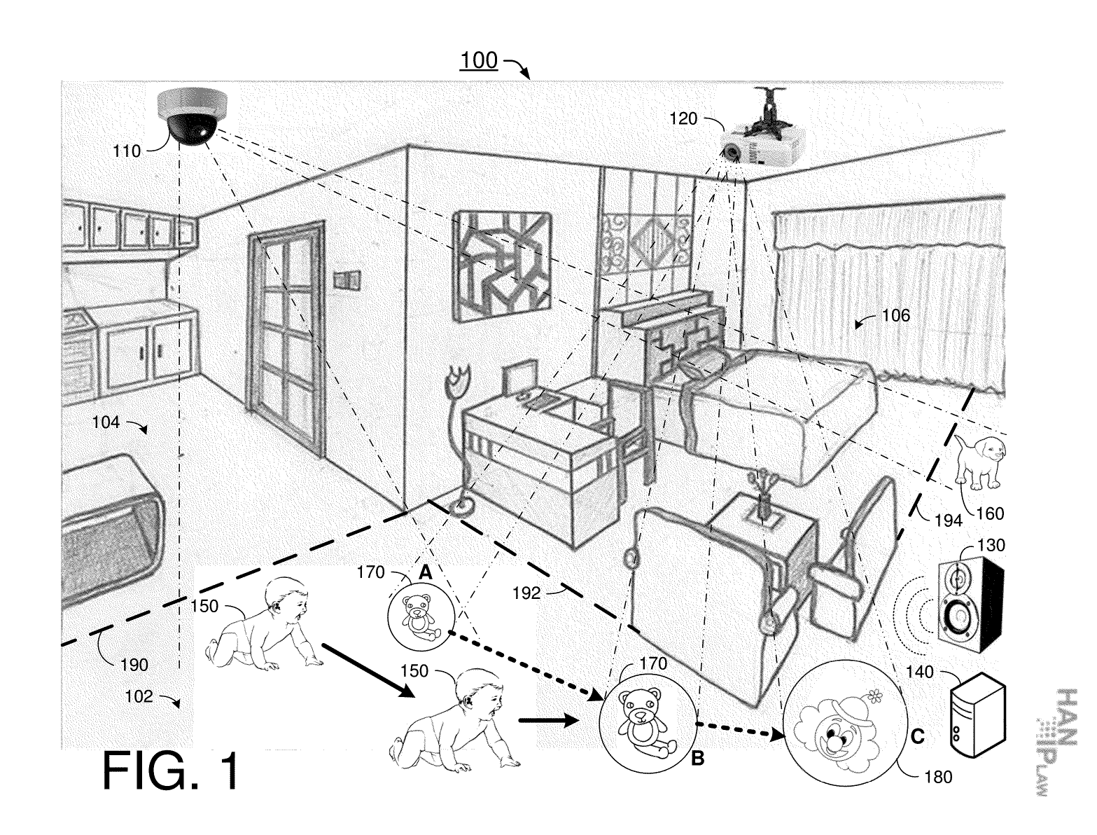

FIG. 1 illustrates an example environment 100 in which various embodiments in accordance with the present disclosure may be implemented. Environment 100 may be a geographic location, an outdoor environment or an indoor environment. Environment 100 may include one or more subjects therein. None or at least one of the one or more subjects in environment 100 at a given time may be a “subject of concern” which may be a crawling baby, a toddler, a young child or even a pet animal that would normally require the care and supervision of a human nanny. In the example shown in FIG. 1, environment 100 is a home environment and includes a crawling baby 150 and a pet dog 160, and each of baby 150 and dog 160 may be a respective subject of concern. Environment 100 may be equipped with one or more sensors, devices, apparatuses and systems in accordance with the present disclosure to provide intelligent nanny assistance. For instance, as shown in FIG. 1, environment 100 is equipped with a monitoring device 110, an image projection device 120, a sound projection device 130 and a computing apparatus 140. Computing apparatus 140 may be communicatively coupled to each of monitoring device 110, image projection device 120 and sound projection device 130, wirelessly and/or via one or more wires, to control the operations thereof to provide intelligent nanny assistance, as described below. Monitoring device 110 may include, but is not limited to, one or more still image cameras, one or more video cameras, one or more depth cameras, one or more heat sensors, or a combination thereof. Image projection device 120 may include, but is not limited to, one or more of a projector, a television, a display device, a smartphone, a computing device, a communication device, or a combination thereof. Sound projection device 130 may include, but is not limited to, one or more speakers, one or more televisions, one or more smartphones, one or more computing devices, one or more communication devices, or a combination thereof.

In the example shown in FIG. 1, environment 100 includes one or more areas or spaces such as, for example, an open area 102, a kitchen area 104 and a living area 106. Areas 102, 104 and 106 may be delineated or otherwise defined by artificial and virtual lines 190, 192 and 194 which may be defined by a user through a computing device (e.g., a personal computer, a laptop computer, a notebook computer, a tablet computer, a smartphone, a smartwatch, a wearable computing device, a portable computing device, a personal digital assistant or the like) which communicates with computing apparatus 140. For instance, the user may view a still image or a video showing environment 100 via computing apparatus 140 and input information, e.g., by using a computer mouse, a keyboard, a touch pad, or a touch-sensing screen, to draw lines 190, 192 and 194 as a way for computing apparatus 140 to learn of the multiple areas in environment 100. According to the present disclosure, at least one of the areas of environment 102 may be predefined by the user as a dangerous or forbidden area with respect to one or more subjects of concern such as baby 150 and/or dog 160. For instance, each of kitchen area 104 and living area 106 may be predefined by the user as a dangerous or forbidden area which baby 150 is not supposed to enter for safety and/or other reasons, while kitchen area 104 but not living area 106 may be defined by the user as a dangerous or forbidden area which dog 160 is not supposed to enter. That is, each subject of concern may be associated with respective one or more predefined areas which may or may not be different from that/those of another subject of concern.

In operation, monitoring device 110 may periodically or continuously scan environment 100 at least partially, including some or all of open area 102, some or all of kitchen area 104 and some or all of living area 106. Monitoring device 110 may provide image-related data as a result of the monitoring, e.g., a series of still images, a series of video clips or a continuous video recording. Computing apparatus 140 may receive the image-related data from monitoring device 110 to identify one or more subjects in environment 100. For instance, computing apparatus 140 may identify baby 150 and dog 160 based on the image-related data received from monitoring device 110, and recognize that either or both of baby 150 and dog 160 may be a subject of concern.

When it appears, based on the image-related data, that a subject of concern in environment 100 is approaching a respective predefined area which the subject of concern is not supposed to enter, computing apparatus 140 may carry out operations in accordance with the present disclosure as part of the intelligence nanny assistance. For instance, when it appears that baby 150 is approaching line 190, which divides open area 102 and kitchen area 104, or line 192, which divides open area 102 and living area 106, or when it appears that dog 160 is approaching line 190, computing apparatus 140 may control either or both of image projection device 120 and sound projection device 130 to project visual information, audible information, or both visual information and audible information in a way that attracts the subject of concern, whether baby 150 or dog 160, to move away from the respective predefined area, e.g., kitchen area 104 or living area 106.

Prior to controlling either or both of image projection device 120 and sound projection device 130 to project visual and/or audible information, computing apparatus 140 may determine or otherwise retrieve one or more items of interest to the subject of concern. For example, baby 150 may interested in toys and mother of baby 150, and thus objects of interest to baby 150 may include one or more sounds, one or more images, one or more videos, or a combination thereof related to toy(s) and/or mother of baby 150. As another example, dog 160 may be interested in bones and master/owner of dog 160, and thus objects of interest to dog 160 may include one or more sounds, one or more images, one or more videos, or a combination thereof related to bone(s) and/or master/owner of dog 160. As another example, when a subject of concern is a cat, which may be interested in rats and sound of another cat, objects of interest to the cat may include one or more sounds, one or more images, one or more videos, or a combination thereof related to rat(s) and/or another cat. Subsequently, computing apparatus 140 may control either or both of image projection device 120 and sound projection device 130 to project visual and/or audible information related to one or more objects of interest to the subject of concern, which may be baby 150 and/or dog 160, to attract the attention thereof.

Computing apparatus 140 may also determine a safe direction or a safe route for the subject of concern to follow so that the subject of concern can eventually move away from the predefined area which the subject of concern is not supposed to enter. Accordingly, computing apparatus 140 may control either or both of image projection device 120 and sound projection device 130 to project visual and/or audible information related to one or more objects of interest in a pattern so as to lead or otherwise guide subject of concern to move in the safe direction or along the safe route to move away from the predefined area.

In performing the above-described operations, computing apparatus 140 may need to achieve a number of tasks. For instance, computing apparatus 140 may need to identify one or more subjects of concern and objects(s) of interest associated with each subject of concern. In that regard, computing apparatus 140 may be configured to recognize one or more objects of interest and link or otherwise correlate each object of interest to a respective subject of concern. Computing apparatus 140 may also need to project visual and/or audible information related to one or more objects of interest associated with a subject of concern to be perceivable by the subject of concern to attract attention thereof. In that regard, computing apparatus 140 may be configured to determine a range of sight of the subject of concern in order to determine an initial point of projection for the visual and/or audible information. Computing apparatus 140 may further need to determine a safe direction or a safe route for the subject of concern to move away from the predefined area. In that regard, computing apparatus 140 may be configured to scan the environment, construct a map of the environment, and determine a safe route.

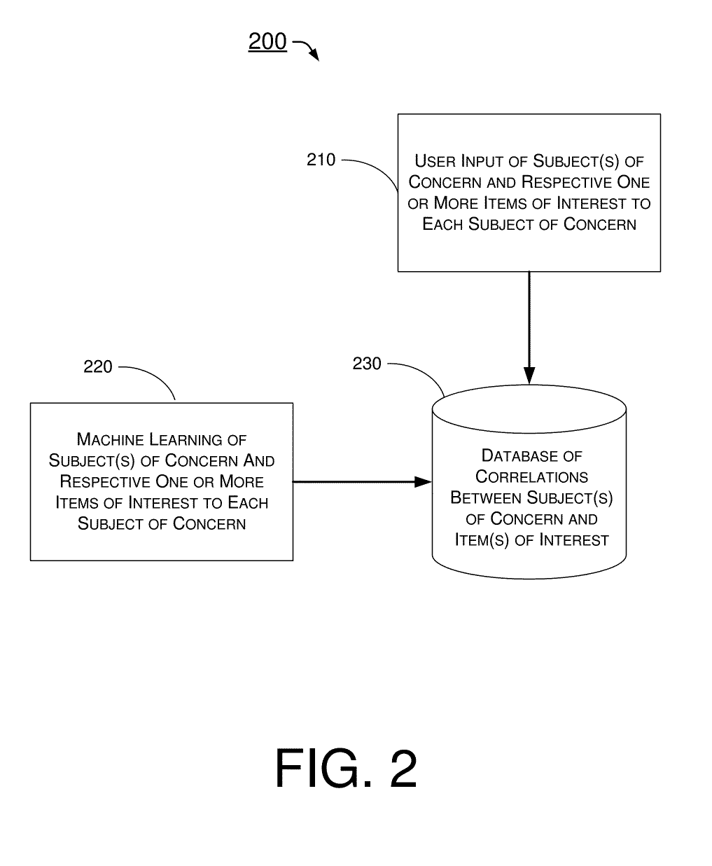

FIG. 2 illustrates an example algorithm 200 pertaining to recognition of one or more objects of interest and correlating each object of interest to a respective subject of concern. Algorithm 200 may include one or more operations, actions, or functions as illustrated by one or more of blocks 210, 220 and 230. Although illustrated as discrete blocks, various blocks may be divided into additional blocks, combined into fewer blocks, or eliminated, depending on the desired implementation. Algorithm 200 may be implemented by computing apparatus 140 in environment 100 and/or system 500 to be described below. It is noteworthy that algorithm 200 may involve either or both of blocks 210 and 220.

At 210, algorithm 200 may involve receiving user input indicative of one or more subjects of concern and respective one or more objects of interest to each of the one or more subjects of concern.

At 220, algorithm 200 may involve machine learning of one or more subjects of concern and respective one or more objects of interest to each of the one or more subjects of concern.

At 230, algorithm 200 may involve establishing a database of correlations between one or more subjects of concern and respective one or more objects of interest to each of the one or more subjects of concern.

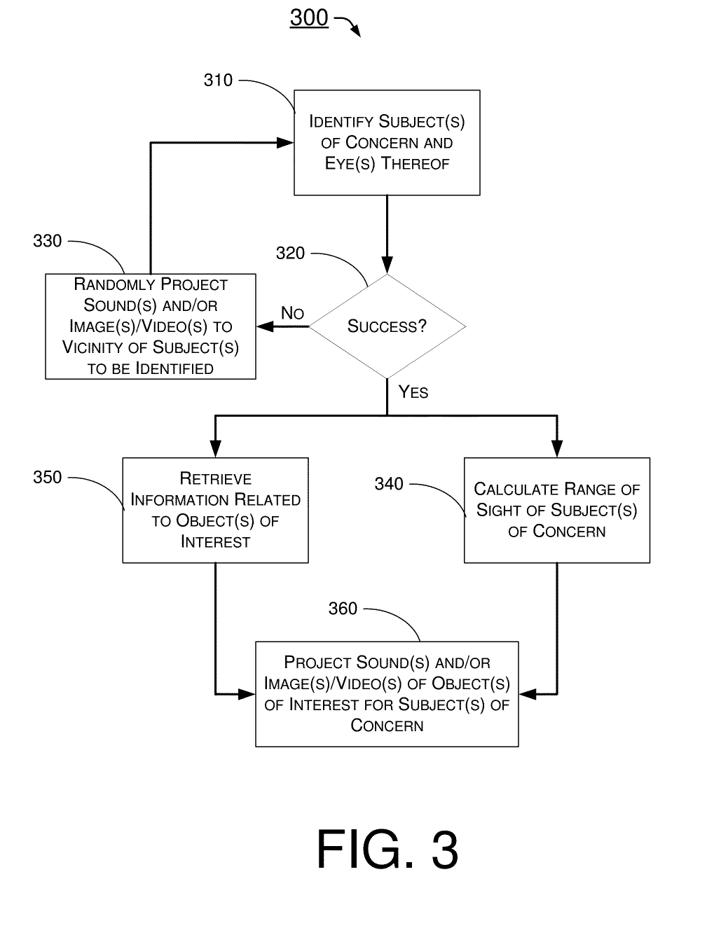

FIG. 3 illustrates an example algorithm 300 pertaining to determination of a range of sight of a subject of concern to determine an initial point of projection. Algorithm 300 may include one or more operations, actions, or functions as illustrated by one or more of blocks 310, 320, 330, 340, 350 and 360. Although illustrated as discrete blocks, various blocks may be divided into additional blocks, combined into fewer blocks, or eliminated, depending on the desired implementation. Algorithm 300 may be implemented by computing apparatus 140 in environment 100 and/or system 500 to be described below.

At 310, algorithm 300 may involve attempting to identify one or more subjects of concern among a number of subjects in an environment and attempting to identify the eye(s) of the identified one or more subjects of concern.

At 320, algorithm 300 may involve determining whether a successful identification of one or more subjects of concern has been achieved. In event that a successful identification of one or more subjects of concern has been achieved, algorithm 300 may proceed to both 340 and 350; otherwise, algorithm 300 may proceed to 330.

At 330, algorithm 300 may involve randomly projecting one or more sounds, one or more images, one or more videos, or a combination thereof to a vicinity of each of the number of subjects to be identified.

At 340, algorithm 300 may involve calculating a range of sight of a subject of concern.

At 350, algorithm 300 may involve retrieving information related to one or more objects of interest to the subject of concern.

At 360, algorithm 300 may involve projecting one or more sounds, one or more images, one or more videos, or a combination thereof related to the one or more objects of interest in a way to attract the subject of concern to move in a direction or along a route so as to safely move away from a predefined area.

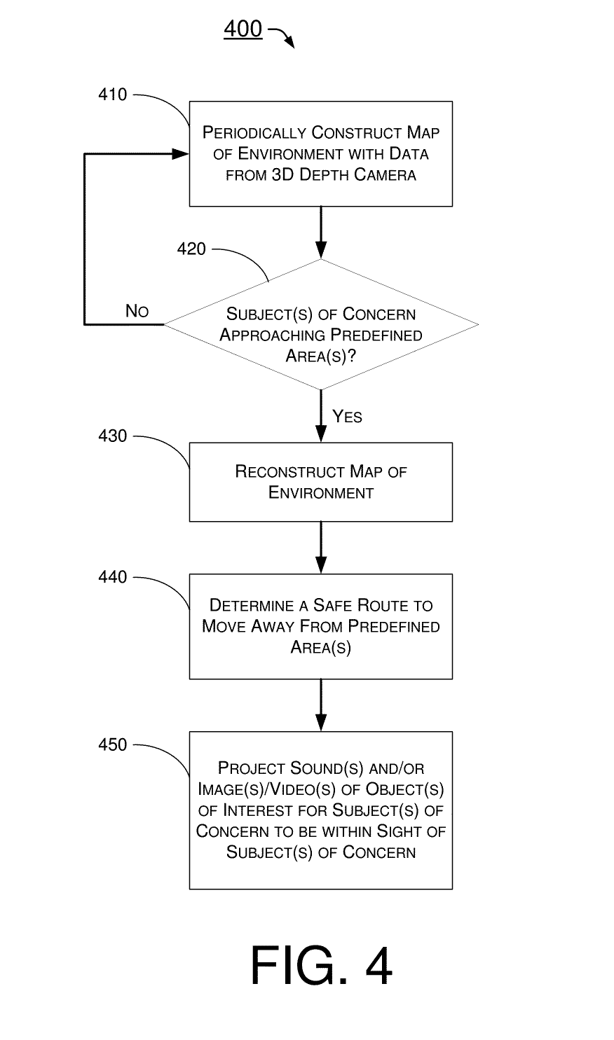

FIG. 4 illustrates an example algorithm 400 pertaining to construction of a map of an environment and determination of a safe route. Algorithm 400 may include one or more operations, actions, or functions as illustrated by one or more of blocks 410, 420, 430, 440 and 450. Although illustrated as discrete blocks, various blocks may be divided into additional blocks, combined into fewer blocks, or eliminated, depending on the desired implementation. Algorithm 400 may be implemented by computing apparatus 140 in environment 100 and/or system 500 to be described below.

At 410, algorithm 400 may involve periodically constructing a map of an environment with data received from a camera, e.g., a three-dimensional (3D) depth camera.

At 420, algorithm 400 may involve determining whether one or more subjects of concern may be approaching one or more predefined areas. In an event of a determination that a subject of concern is approaching a respective predefined area, algorithm 400 may proceed to 430; otherwise, algorithm 400 may return to 410.

At 430, algorithm 400 may involve reconstructing the map of the environment subsequent to the determination that a subject of concern is approaching a respective predefined area.

At 440, algorithm 400 may involve determining a safe route for the subject of concern to move away from the predefined area.

At 450, algorithm 400 may involve projecting one or more sounds, one or more images, one or more videos, or a combination thereof related to the one or more objects of interest to be within sight of the subject of concern.

### Example Implementations

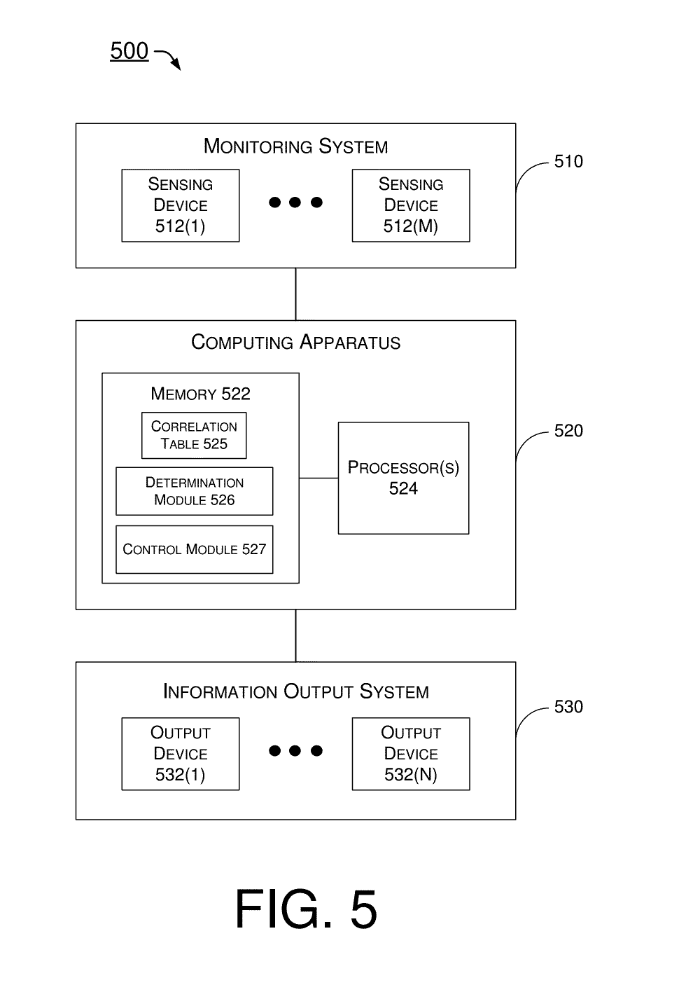

FIG. 5 illustrates an example system 500 in accordance with an implementation of the present disclosure. System 500 may perform various functions related to techniques, methods and systems described herein. In some implementations, system 500 may include at least those components shown in FIG. 5, such as a monitoring system 510, a computing apparatus 520 and an information output system 530. System 500 may implement example algorithms 200, 300 and 400 described above.

Monitoring system 510 may be configured to monitor an environment (e.g., environment 100) to periodically or continuously provide image-related data of a scan of the environment. Monitoring system 510 may be an example implementation of monitoring device 110, and may include one or more sensors 512(1)-512(M) with M being a positive integer equal to or greater than 1. For example and not limited thereto, the one or more sensors 512(1)-512(M) may include one or more still image cameras, one or more video cameras, one or more depth cameras, one or more heat sensors, or a combination thereof.

Information output system 530 may be situated in the environment and configured to provide visual information, audible information, or a combination thereof. Information output system 530 may be an example implementation of image projection device 120 and sound projection device 130, and may include one or more output devices 532(1)-532(N) with N being a positive integer equal to or greater than 1. For example and not limited thereto, the one or more output devices 532(1)-532(N) may include one or more speakers, one or more televisions, one or more smartphones, one or more computing devices, one or more communication devices, or a combination thereof.

Computing apparatus 520 may be communicatively coupled to monitoring system 510 and information output system 530. Computing apparatus 520 may include a memory 522 configured to store data therein and one or more processors 524 configured to access memory 522. In some implementations, memory 522 may store one or more processor-executable sets of instructions or software modules such as, for example, a determination module 526 and a control module 527.

Processor(s) 524 may be configured to receive image-related data from monitoring system 510. Processor(s) 524 may be also configured to determine whether a subject of concern (e.g., baby 150 or dog 160) is approaching a predefined area (e.g., kitchen area 104 or living area 106) of the environment based on the image-related data. In some implementations, processor(s) 524 may execute the determination module 526 to operations pertaining to determination described herein. In response to a determination that the subject of concern is approaching the predefined area, processor(s) 524 may be further configured to control information output system 530 to provide the visual information, the audible information, or both the visual information and the audible information in a way that attracts the subject of concern to move away from the predefined area. In some implementations, processor(s) 524 may execute the control module 527 to perform operations pertaining to controlling described herein.

In some implementations, the visual information may include one or more images, one or more pictures, one or more graphics, one or more animations, one or more video clips, or a combination thereof. In some implementations, the audible information may include one or more sounds, one or more voices, one or more commands, or a combination thereof.

In some implementations, in determining whether the subject of concern is approaching the predefined area, processor(s) 524 may be configured to identify the predefined area within the environment and determine whether a movement of the subject of concern indicates that the subject of concern is approaching the predefined area based on the image-related data.

In some implementations, in controlling information output system 530 to provide the visual information, the audible information, or both the visual information and the audible information in a way that attracts the subject of concern to move away from the predefined area, processor(s) 524 may be configured to control information output system 530 to provide the visual information, the audible information, or both the visual information and the audible information to guide the subject of concern to move in a direction or along a route to move away from the predefined area.

In some implementations, monitoring system 510 may include at least a depth camera, and process(s) 524 may be further configured to receive a first user input defining the predefined area in the environment, construct a map of the environment based on the image-related data captured by the depth camera, and determine the direction or the route according to a spatial relation between the subject of concern and the predefined area based on the map.

Alternatively or additionally, processor(s) 524 may be further configured to perform a number of operations. For instance, processor(s) 524 may receive a second user input identifying one or more objects as one or more objects of danger and identify at least one object in the environment as one of the one or more objects of danger based on the image-related data. In constructing the map of the environment, processor(s) 524 may be configured to construct the map with the predefined area and a newly defined area surrounding the at least one object in the environment identified in the map. In determining the direction or the route, processor(s) 524 may be configured to determine the direction or the route according to a spatial relation between the subject of concern, the predefined area and the newly defined area based on the map.

In some implementations, monitoring system 510 may include at least a heat sensor, and process(s) 524 may be further configured to receive, from the heat sensor, data indicative of a heat source in the environment, construct a map with the predefined area and a newly defined area surrounding the heat source identified in the map, and determine the direction or the route according to a spatial relation between the subject of concern, the predefined area and the newly defined area based on the map.

In some implementations, in controlling information output system 530 to provide the visual information, the audible information, or both the visual information and the audible information in a way that attracts the subject of concern to move away from the predefined area, processor(s) 524 may be configured to determine a range of sight of the subject of concern based on the image-related data and control information output system 530 to project visual information to an area within the range of sight of the subject of concern.

In some implementations, processor(s) 524 may be further configured to perform a number of operations. For instance, processor(s) 524 may receive a first input identifying the subject of concern and receive a second input identifying the one or more items of interest. Processor(s) 524 may also establish a correlation between the one or more items of interest to the subject of concern based on the first input and the second input. Processor(s) 524 may further store in the memory the first input, the second input, and the correlation between the one or more items of interest to the subject of concern. For instance, processor(s) 524 may store the first input, the second input and the correlation in a correlation table 525 which may be stored in memory 522. In some implementations, in determining whether the subject of concern is approaching the predefined area in the environment, processor(s) 524 may be configured to perform a number of operations. For instance, processor(s) 524 may identify one or more subjects in the environment based on the image-related data. Processor(s) 524 may also determine that one of the one or more subjects in the environment is the subject of concern. Processor(s) 524 may further retrieve information related to one or more items of interest correlated to the subject of concern. For instance, processor(s) 524 may retrieve the information from correlation table 525.

Alternatively or additionally, processor(s) 524 may be further configured to perform a number of operations. For instance, processor(s) 524 may perform machine learning to identifying the subject of concern from a plurality of subjects and to identify one or more items of interest from a plurality of objects. Processor(s) 524 may also establish a correlation between the one or more items of interest to the subject of concern based on the first input and the second input. Processor(s) 524 may further store in the memory the first input, the second input, and the correlation between the one or more items of interest to the subject of concern. For instance, processor(s) 524 may store the first input, the second input and the correlation in correlation table 525.

In some implementations, processor(s) 524 may be further configured to perform a number of operations. For instance, in response to the determination that the subject of concern is approaching the predefined area, processor(s) 524 may generate a signal indicative of the determination and cause a transmission of the signal. The signal may be a human perceivable signal or a signal received and processed by a device to be presented to a user.

In some implementations, prior to the determining of whether the subject of concern is approaching the predefined area in the environment, processor(s) 524 may identify the subject of concern from a plurality of subjects of concern by performing a number of operations. For instance, processor(s) 524 may determine whether a first subject in the environment is one of the subjects of concern based on the image-related data. In response to a determination that the first subject is not one of the subjects of concern, processor(s) 524 may randomly project one or more sounds, one or more images, one or more videos, or a combination thereof to a vicinity of the subject. In response to a determination that the first subject is one of the subjects of concern, processor(s) 524 may determine a range of sight of the subject and retrieve information related to one or more objects of interest with respect to the subject so that the information is provided in a way that attracts the first subject to move away from the predefined area in response to a determination that the first subject is approaching the predefined area. For instance, processor(s) 524 may retrieve the information from correlation table 525.

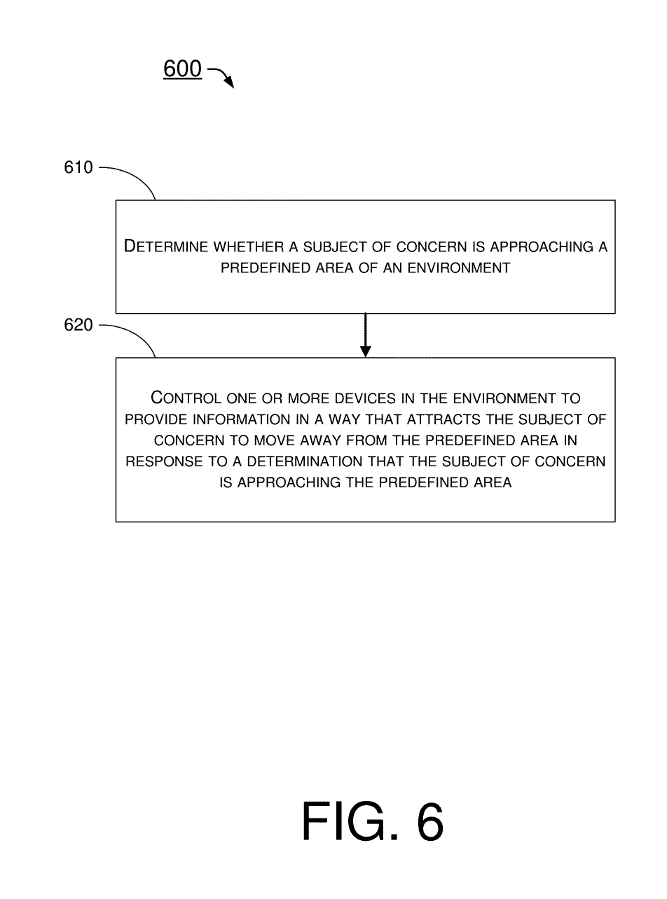

FIG. 6 illustrates an example process 600 in accordance with an implementation of the present disclosure. Process 600 may include one or more operations, actions, or functions as illustrated by one or more of blocks 610 and 620. Although illustrated as discrete blocks, various blocks may be divided into additional blocks, combined into fewer blocks, or eliminated, depending on the desired implementation. Process 600 may be implemented by computing apparatus 140 in environment 100 and/or one or more processors 524 of apparatus 500. For illustrative purposes, the operations described below with respect to process 600 are performed by computing apparatus 140 in the context of environment 100. Process 600 may begin at block 610.

At block 610, process 600 may involve computing apparatus 140 determining whether a subject of concern is approaching a predefined area of an environment. For instance, process 600 may involve computing apparatus 140 determining whether baby 150 is approaching kitchen area 104 in environment 100. Block 610 may be followed by block 620.

At 620, process 600 may involve computing apparatus 140 controlling one or more devices in the environment to provide information in a way that attracts the subject of concern to move away from the predefined area in response to a determination that the subject of concern is approaching the predefined area. For instance, process 600 may involve computing apparatus 140 controlling either or both image projection device 120 and sound projection device 130 to provide visual and/or audible information to attract baby 150 to move away from kitchen area 104.

In some implementations, the information may include visual information, audible information, or both the visual and the audible information related to one or more items of interest to the subject of concern. In some implementations, the visual information may include one or more images, one or more pictures, one or more graphics, one or more animations, one or more video clips, or a combination thereof. In some implementations, the audible information may include one or more sounds, one or more voices, one or more commands, or a combination thereof.

In some implementations, in determining whether the subject of concern is approaching the predefined area, process 600 may involve computing apparatus 140 receiving image-related data from a monitoring system that monitors the environment, identifying the predefined area within the environment, and determining whether a movement of the subject of concern indicates that the subject of concern is approaching the predefined area based on the image-related data.

In some implementations, in controlling the one or more devices in the environment to provide information in a way that attracts the subject of concern to move away from the predefined area, process 600 may involve computing apparatus 140 controlling the one or more devices in the environment to provide the information to guide the subject of concern to move in a direction or along a route to move away from the predefined area.

In some implementations, in controlling, process 600 may involve computing apparatus 140 receiving image-related data from a monitoring system (e.g., monitoring device 110) that monitors the environment and receiving a first user input defining the predefined area of the environment. Process 600 may also involve computing apparatus 140 constructing a map of the environment based on the image-related data. Process 600 may further involve computing apparatus 140 determining the direction or the route according to a spatial relation between the subject of concern and the predefined area based on the map. In some implementations, process 600 may involve computing apparatus 140 receiving a second user input identifying one or more objects as one or more objects of danger and identifying at least one object in the environment as one of the one or more objects of danger based on the image-related data. In constructing the map of the environment, process 600 may involve computing apparatus 140 constructing the map with the predefined area and a newly defined area surrounding the at least one object in the environment identified in the map. In determining the direction or the route, process 600 may involve computing apparatus 140 determining the direction or the route according to a spatial relation between the subject of concern, the predefined area and the newly defined area based on the map.

Alternatively or additionally, in controlling, process 600 may involve computing apparatus 140 receiving, from a heat sensor, data indicative of a heat source in the environment. Process 600 may also involve computing apparatus 140 constructing a map with the predefined area and a newly defined area surrounding the heat source identified in the map. Process 600 may further involve computing apparatus 140 determining the direction or the route according to a spatial relation between the subject of concern, the predefined area and the newly defined area based on the map.

In some implementations, in controlling the one or more devices in the environment to provide information in a way that attracts the subject of concern to move away from the predefined area, process 600 may involve computing apparatus 140 receiving image-related data from a monitoring system that monitors the environment. Process 600 may also involve computing apparatus 140 determining a range of sight of the subject of concern based on the image-related data. Process 600 may further involve computing apparatus 140 controlling the one or more devices to project visual information to an area within the range of sight of the subject of concern.

In some implementations, process 600 may additionally involve computing apparatus 140 performing operations including the following: receiving a first input identifying the subject of concern, receiving a second input identifying the one or more items of interest, establishing a correlation between the one or more items of interest to the subject of concern based on the first input and the second input, and storing the first input, the second input, and the correlation between the one or more items of interest to the subject of concern. In some implementations, in determining whether the subject of concern is approaching the predefined area of the environment, process 600 may additionally involve computing apparatus 140 receiving image-related data from a monitoring system that monitors the environment and identifying one or more subjects in the environment based on the image-related data. Process 600 may also involve computing apparatus 140 determining that one of the one or more subjects in the environment is the subject of concern. Process 600 may further involve computing apparatus 140 retrieving information related to one or more items of interest correlated to the subject of concern.

Alternatively or additionally, process 600 may additionally involve computing apparatus 140 performing operations including the following: performing machine learning to identifying the subject of concern from a plurality of subjects and to identify the one or more items of interest from a plurality of objects, establishing a correlation between the one or more items of interest to the subject of concern based on the first input and the second input, and storing the first input, the second input, and the correlation between the one or more items of interest to the subject of concern.

Alternatively or additionally, process 600 may additionally involve computing apparatus 140 transmitting a signal indicative of the determination in response to the determination that the subject of concern is approaching the predefined area. The signal may be a human perceivable signal or a signal received and processed by a device to be presented to a user.

In some implementations, prior to the determining of whether the subject of concern is approaching the predefined area of the environment, process 600 may involve computing apparatus 140 identifying the subject of concern from a plurality of subjects of concern by performing a number of operations. For instance, process 600 may involve computing apparatus 140 receiving image-related data from a monitoring system that monitors the environment and determining whether a first subject in the environment is one of the subjects of concern based on the image-related data. Process 600 may involve computing apparatus 140 randomly projecting one or more sounds, one or more images, one or more videos, or a combination thereof to a vicinity of the subject in response to a determination that the first subject is not one of the subjects of concern. Otherwise, in response to a determination that the first subject is one of the subjects of concern, process 600 may involve computing apparatus 140 determining a range of sight of the subject and retrieving information related to one or more objects of interest with respect to the subject so that the information is provided in a way that attracts the first subject to move away from the predefined area in response to a determination that the first subject is approaching the predefined area.

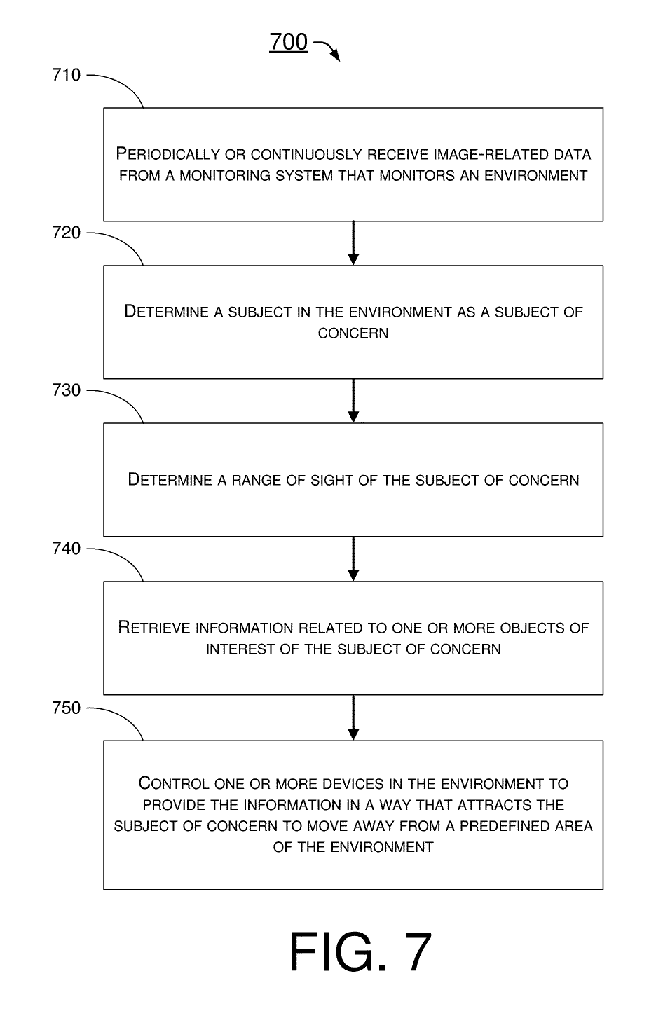

FIG. 7 illustrates an example algorithm 700 in accordance with an implementation of the present disclosure. Process 700 may include one or more operations, actions, or functions as illustrated by one or more of blocks 710, 720, 730, 740 and 750. Although illustrated as discrete blocks, various blocks may be divided into additional blocks, combined into fewer blocks, or eliminated, depending on the desired implementation. Process 700 may be implemented by computing apparatus 140 in environment 100 and/or one or more processors 524 of apparatus 500. For illustrative purposes, the operations described below with respect to process 700 are performed by computing apparatus 140 in the context of environment 100. Process 700 may begin at block 710.

At block 710, process 700 may involve computing apparatus 140 periodically or continuously receiving image-related data from a monitoring system that monitors an environment. For instance, process 700 may involve computing apparatus 140 periodically or continuously receiving image-related data from monitoring device 110 that monitors environment 100. Block 710 may be followed by block 720.

At block 720, process 700 may involve computing apparatus 140 determining a subject in the environment as a subject of concern. For instance, process 700 may involve computing apparatus 140 determining that baby 150 in environment 100 is a subject of concern. Block 720 may be followed by block 730.

At block 730, process 700 may involve computing apparatus 140 determining a range of sight of the subject of concern. For instance, process 700 may involve computing apparatus 140 determining a range of sight of baby 150. Block 730 may be followed by block 740.

At block 740, process 700 may involve computing apparatus 140 retrieving information related to one or more objects of interest of the subject of concern. For instance, process 700 may involve computing apparatus 140 retrieving information related to one or more pictures, photos, images, animations and/or sounds that are of interest to baby 150. Block 740 may be followed by block 750.

At block 750, process 700 may involve computing apparatus 140 controlling one or more devices in the environment to provide the information in a way that attracts the subject of concern to move away from a predefined area of the environment. For instance, process 700 may involve computing apparatus 140 controlling either or both of image projection device 120 and sound projection device 130 to project visual and/or audible information in a way that attracts baby 150 to move away from kitchen area 104.

In some implementations, in determining the at least one of the one or more subjects as the subject of concern, process 700 may involve computing apparatus 140 determining whether the subject in the environment can be identified as any of one or more subjects of concern based on the image-related data. In response to a determination that the subject cannot be identified as any of the one or more subjects of concern, process 700 may involve computing apparatus 140 randomly projecting one or more sounds, one or more images, one or more videos, or a combination thereof to a vicinity of the subject. Process 700 may also involve computing apparatus 140 determining whether the subject is one of the one or more subjects of concern based on a response of the subject to the projecting.

In some implementations, process 700 may additionally involve computing apparatus 140 performing a number of operations. For instance, process 700 may involve computing apparatus 140 receiving a first input identifying the subject of concern and receiving a second input identifying the one or more items of interest. Process 700 may also involve computing apparatus 140 establishing a correlation between the one or more items of interest to the subject of concern based on the first input and the second input. Process 700 may further involve computing apparatus 140 storing the first input, the second input, and the correlation between the one or more items of interest to the subject of concern.

Alternatively or additionally, process 700 may additionally involve computing apparatus 140 performing a number of operations. For instance, process 700 may involve computing apparatus 140 performing machine learning to identifying the subject of concern from a plurality of subjects and to identify the one or more items of interest from a plurality of objects. Process 700 may also involve computing apparatus 140 establishing a correlation between the one or more items of interest to the subject of concern based on the first input and the second input. Process 700 may further involve computing apparatus 140 storing the first input, the second input, and the correlation between the one or more items of interest to the subject of concern.

Alternatively or additionally, process 700 may additionally involve computing apparatus 140 performing a number of operations. For instance, process 700 may involve computing apparatus 140 periodically performing operations including constructing a map of the environment based on the image-related data and determining whether the subject of concern is approaching the predefined area. In response to a determination that the subject of concern is approaching the predefined area, process 700 may involve computing apparatus 140 reconstructing the map of the environment based on the image-related data and determining a direction or a route through which to move the subject of concern to move away from the predefined area. In controlling the one or more devices in the environment to provide the information in a way that attracts the subject of concern to move away from the predefined area of the environment, process 700 may involve computing apparatus 140 controlling the one or more devices in the environment to provide visual information, audible information, or both the visual information and the audible information to guide the subject of concern to move in the direction or along the route to move away from the predefined area.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
determining whether a subject of concern is approaching a predefined area of an environment; and
in response to a determination that the subject of concern is approaching the predefined area, controlling one or more devices in the environment to provide information in a way that attracts the subject of concern to move away from the predefined area.

2. The method of claim 1, wherein the information comprises visual information, audible information, or both the visual and the audible information related to one or more items of interest to the subject of concern.

3. The method of claim 1, wherein the determining of whether the subject of concern is approaching the predefined area comprises:
receiving image-related data from a monitoring system that monitors the environment;
identifying the predefined area within the environment; and
determining whether a movement of the subject of concern indicates that the subject of concern is approaching the predefined area based on the image-related data.

4. The method of claim 1, wherein the controlling of the one or more devices in the environment to provide information in a way that attracts the subject of concern to move away from the predefined area comprises controlling the one or more devices in the environment to provide the information to guide the subject of concern to move in a direction or along a route to move away from the predefined area.

5. The method of claim 4, wherein the controlling further comprises:
receiving image-related data from a monitoring system that monitors the environment;
receiving a first user input defining the predefined area of the environment;
constructing a map of the environment based on the image-related data; and
determining the direction or the route according to a spatial relation between the subject of concern and the predefined area based on the map.

6. The method of claim 5, further comprising:
receiving a second user input identifying one or more objects as one or more objects of danger; and
identifying at least one object in the environment as one of the one or more objects of danger based on the image-related data,
wherein the constructing of the map of the environment comprises constructing the map with the predefined area and a newly defined area surrounding the at least one object in the environment identified in the map, and
wherein the determining of the direction or the route comprises determining the direction or the route according to a spatial relation between the subject of concern, the predefined area and the newly defined area based on the map.

7. The method of claim 4, wherein the controlling further comprises:
receiving, from a heat sensor, data indicative of a heat source in the environment;
constructing a map with the predefined area and a newly defined area surrounding the heat source identified in the map; and
determining the direction or the route according to a spatial relation between the subject of concern, the predefined area and the newly defined area based on the map.

8. The method of claim 1, wherein the controlling of the one or more devices in the environment to provide information in a way that attracts the subject of concern to move away from the predefined area comprises:
receiving image-related data from a monitoring system that monitors the environment;
determining a range of sight of the subject of concern based on the image-related data; and
controlling the one or more devices to project visual information to an area within the range of sight of the subject of concern.

9. The method of claim 1, further comprising:
receiving a first input identifying the subject of concern;
receiving a second input identifying the one or more items of interest;
establishing a correlation between the one or more items of interest to the subject of concern based on the first input and the second input; and
storing the first input, the second input, and the correlation between the one or more items of interest to the subject of concern.

10. The method of claim 9, wherein the determining of whether the subject of concern is approaching the predefined area of the environment comprises:
receiving image-related data from a monitoring system that monitors the environment;
identifying one or more subjects in the environment based on the image-related data;
determining that one of the one or more subjects in the environment is the subject of concern; and
retrieving information related to one or more items of interest correlated to the subject of concern.

11. The method of claim 1, further comprising:
performing machine learning to identifying the subject of concern from a plurality of subjects and to identify the one or more items of interest from a plurality of objects;
establishing a correlation between the one or more items of interest to the subject of concern based on the first input and the second input; and
storing the first input, the second input, and the correlation between the one or more items of interest to the subject of concern.

12. The method of claim 1, further comprising:
in response to the determination that the subject of concern is approaching the predefined area, transmitting a signal indicative of the determination,
wherein the signal is a human perceivable signal or a signal received and processed by a device to be presented to a user.

13. The method of claim 1, further comprising:
prior to the determining of whether the subject of concern is approaching the predefined area of the environment, identifying the subject of concern from a plurality of subjects of concern by performing operations comprising:
receiving image-related data from a monitoring system that monitors the environment;
determining whether a first subject in the environment is one of the subjects of concern based on the image-related data;
in response to a determination that the first subject is not one of the subjects of concern, randomly projecting one or more sounds, one or more images, one or more videos, or a combination thereof to a vicinity of the subject; and
in response to a determination that the first subject is one of the subjects of concern, performing operations comprising:
determining a range of sight of the subject; and
retrieving information related to one or more objects of interest with respect to the subject so that the information is provided in a way that attracts the first subject to move away from the predefined area in response to a determination that the first subject is approaching the predefined area.

14. A method, comprising:
periodically or continuously receiving image-related data from a monitoring system that monitors an environment;
determining a subject in the environment as a subject of concern;
determining a range of sight of the subject of concern;
retrieving information related to one or more objects of interest of the subject of concern; and
controlling one or more devices in the environment to provide the information in a way that attracts the subject of concern to move away from a predefined area of the environment.

15. The method of claim 14, wherein the determining of the at least one of the one or more subjects as the subject of concern comprises:
determining whether the subject in the environment can be identified as any of one or more subjects of concern based on the image-related data;
in response to a determination that the subject cannot be identified as any of the one or more subjects of concern, performing operations comprising:
randomly projecting one or more sounds, one or more images, one or more videos, or a combination thereof to a vicinity of the subject; and
determining whether the subject is one of the one or more subjects of concern based on a response of the subject to the projecting.

16. The method of claim 14, further comprising:
receiving a first input identifying the subject of concern;
receiving a second input identifying the one or more items of interest;
establishing a correlation between the one or more items of interest to the subject of concern based on the first input and the second input; and
storing the first input, the second input, and the correlation between the one or more items of interest to the subject of concern.

17. The method of claim 14, further comprising:
performing machine learning to identifying the subject of concern from a plurality of subjects and to identify the one or more items of interest from a plurality of objects;
establishing a correlation between the one or more items of interest to the subject of concern based on the first input and the second input; and
storing the first input, the second input, and the correlation between the one or more items of interest to the subject of concern.

18. The method of claim 14, further comprising:
periodically performing operations comprising:
constructing a map of the environment based on the image-related data; and
determining whether the subject of concern is approaching the predefined area; and
in response to a determination that the subject of concern is approaching the predefined area, performing operations comprising:
reconstructing the map of the environment based on the image-related data; and
determining a direction or a route through which to move the subject of concern to move away from the predefined area,
wherein the controlling of the one or more devices in the environment to provide the information in a way that attracts the subject of concern to move away from the predefined area of the environment comprises controlling the one or more devices in the environment to provide visual information, audible information, or both the visual information and the audible information to guide the subject of concern to move in the direction or along the route to move away from the predefined area.

19. A system, comprising:
a monitoring system configured to monitor an environment to periodically or continuously provide image-related data of the environment;
an information output system situated in the environment and configured to provide visual information, audible information, or a combination thereof
a computing apparatus communicatively coupled to the monitoring system and the information output system, the computing apparatus comprising:
a memory configured to store data; and
a processor configured to access the memory, the processor configured to perform operations comprising:
receiving image-related data from the monitoring system;
determining whether a subject of concern is approaching a predefined area of the environment based on the image-related data; and
in response to a determination that the subject of concern is approaching the predefined area, controlling the information output system to provide the visual information, the audible information, or both the visual information and the audible information in a way that attracts the subject of concern to move away from the predefined area.

20. The system of claim 19, wherein, in determining whether the subject of concern is approaching the predefined area, the processor is configured to perform operations comprising:
identifying the predefined area within the environment; and
determining whether a movement of the subject of concern indicates that the subject of concern is approaching the predefined area based on the image-related data.

21. The system of claim 19, wherein, in controlling the information output system to provide the visual information, the audible information, or both the visual information and the audible information in a way that attracts the subject of concern to move away from the predefined area, the processor is configured to control the information output system to provide the visual information, the audible information, or both the visual information and the audible information to guide the subject of concern to move in a direction or along a route to move away from the predefined area.

22. The system of claim 21, wherein the monitoring system comprises at least a depth camera, and wherein the processor is further configured to perform operations comprising:
receiving a first user input defining the predefined area in the environment;
constructing a map of the environment based on the image-related data captured by the depth camera; and
determining the direction or the route according to a spatial relation between the subject of concern and the predefined area based on the map.

23. The system of claim 22, wherein the processor is further configured to perform operations comprising:
receiving a second user input identifying one or more objects as one or more objects of danger; and
identifying at least one object in the environment as one of the one or more objects of danger based on the image-related data,
wherein, in constructing the map of the environment, the processor is configured to construct the map with the predefined area and a newly defined area surrounding the at least one object in the environment identified in the map, and
wherein, in determining the direction or the route, the processor is configured to determine the direction or the route according to a spatial relation between the subject of concern, the predefined area and the newly defined area based on the map.

24. The system of claim 23, wherein the monitoring system comprises at least a heat sensor, and wherein the processor is further configured to perform operations comprising:
receiving, from the heat sensor, data indicative of a heat source in the environment;
constructing a map with the predefined area and a newly defined area surrounding the heat source identified in the map; and
determining the direction or the route according to a spatial relation between the subject of concern, the predefined area and the newly defined area based on the map.

25. The system of claim 19, wherein, in controlling the information output system to provide the visual information, the audible information, or both the visual information and the audible information in a way that attracts the subject of concern to move away from the predefined area, the processor is configured to perform operations comprising:
determining a range of sight of the subject of concern based on the image-related data; and
controlling the information output system to project visual information to an area within the range of sight of the subject of concern.

26. The system of claim 19, wherein the processor is further configured to perform operations comprising:
receiving a first input identifying the subject of concern;
receiving a second input identifying the one or more items of interest;
establishing a correlation between the one or more items of interest to the subject of concern based on the first input and the second input; and
storing in the memory the first input, the second input, and the correlation between the one or more items of interest to the subject of concern.

27. The system of claim 26, wherein, in determining whether the subject of concern is approaching the predefined area in the environment, the processor is configured to perform operations comprising:
identifying one or more subjects in the environment based on the image-related data;
determining that one of the one or more subjects in the environment is the subject of concern; and
retrieving information related to one or more items of interest correlated to the subject of concern.

28. The system of claim 19, wherein the processor is further configured to perform operations comprising:
performing machine learning to identifying the subject of concern from a plurality of subjects and to identify one or more items of interest from a plurality of objects;
establishing a correlation between the one or more items of interest to the subject of concern based on the first input and the second input; and
storing in the memory the first input, the second input, and the correlation between the one or more items of interest to the subject of concern.

29. The system of claim 19, wherein the processor is further configured to perform operations comprising:
in response to the determination that the subject of concern is approaching the predefined area, generating a signal indicative of the determination; and
causing a transmission of the signal,
wherein the signal is a human perceivable signal or a signal received and processed by a device to be presented to a user.

30. The system of claim 19, wherein the processor is further configured to perform operations comprising:
prior to the determining of whether the subject of concern is approaching the predefined area in the environment, identifying the subject of concern from a plurality of subjects of concern by performing operations comprising:
determining whether a first subject in the environment is one of the subjects of concern based on the image-related data;
in response to a determination that the first subject is not one of the subjects of concern, randomly projecting one or more sounds, one or more images, one or more videos, or a combination thereof to a vicinity of the subject; and
in response to a determination that the first subject is one of the subjects of concern, performing operations comprising:
determining a range of sight of the subject; and
retrieving information related to one or more objects of interest with respect to the subject so that the information is provided in a way that attracts the first subject to move away from the predefined area in response to a determination that the first subject is approaching the predefined area.

31. The system of claim 19, wherein the information output system comprises one or more speakers, one or more televisions, one or more smartphones, one or more computing devices, one or more communication devices, or a combination thereof.
